(19) United States
(12) Patent Application Publication
(10) Pub. No.: US 2009/0033409 A1
(43) Pub. Date: Feb. 5, 2009

(54) Bias correction device

(75) Inventors: Yung-Hsiang Shih, Taoyuan Hsien (TW); Canny Cheng, Taoyuan Hsien (TW)

Correspondence Address: Joe McKinney Muncy, PO Box 1364, Fairfax, VA, 22038-1364, US

(73) Assignee: FSP TECHNOLOGY INC.

(21) Appl. No.: 11/882,537

(22) Filed: Aug. 2, 2007

(51) Int. Cl. G05F 1/44; G05F 3/02

(52) U.S. Cl. 327/538

(57) ABSTRACT

A bias correction device to be used on a power supply which has a high voltage output end and a low voltage output end bridges the high voltage output end and the low voltage output end. When the output voltage at the low voltage output end is too low the bias correction device makes the high voltage output end to output a voltage to compensate the low voltage output end so that the voltage at the low voltage output end is raised to be maintained a preset output voltage level.

### FIELD OF THE INVENTION

The present invention relates to a bias correction device and particularly to a correction device adopted for use on a power supply to output a high voltage to compensate error of low voltage output and reduce loss.

### BACKGROUND OF THE INVENTION

In regular machine start process of computer elements a power supply ought to provide power to the computer elements within a set time series after having received a machine start command to enable the computer elements to start operation. The computer elements operate under different duty voltages. Hence the power supply must provide output voltage at different levels to meet the requirements of various elements. To generate different voltages, the common approach is to capture current from a main output end of a higher voltage and lower the voltage through a DC/DC converter to provide a sub-output. When the computer is started the time series of voltage output by the power supply and machine start of the computer elements have to be controlled to avoid not timely machine start of the computer elements and abnormal operation of the computer. To start all the elements correctly, the most common method is using a resistor as a virtual load coupled in parallel with the sub-output end. This can stabilize the voltage at the sub-output end at the initial machine start time so that the computer elements can be started normally. However, while the virtual load can prohibit voltage fluctuation of the sub-output, it also increases loss. The loss becomes greater as the sub-output increases. Such a loss resulted from the virtual load is significant for the power supply of a greater watts and a higher power factor. There is a need to provide an improved technique to prohibit the voltage fluctuation of the sub-output.

### SUMMARY OF THE INVENTION

In order to solve the problem of loss occurred to the conventional virtual load set forth above the primary object of the present invention is to provide a circuit that can reduce loss and prohibit voltage fluctuation of sub-output.

The present invention provides a bias correction device to be used in a power supply. The power supply has at least one high voltage output end and one low voltage output end formed according to output voltage levels. The bias correction device bridges the high voltage output end and the low voltage output end to set an ideal voltage difference between the high voltage output end and the low voltage output end. In the event that the voltage is not adequate at the low voltage output end and the actual voltage difference between the high voltage output end and the low voltage output end is greater than the ideal voltage difference, the bias correction device makes conductive connection between the high voltage output end and the low voltage output end. By boosting the voltage at the low voltage output end through the high voltage output end the voltage at the low voltage output end can be maintained at a preset voltage level.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of the invention.

FIG. 2 is a block diagram of an embodiment of the invention.

### DETAILED DESCRIPTION OF THE PREFERRED EMBODIMENT

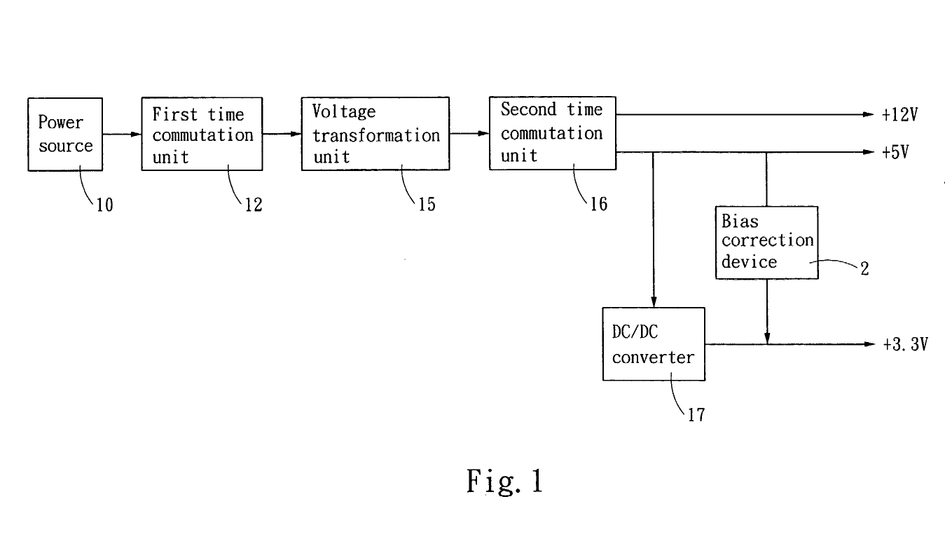

Please refer to FIG. 1 for a block diagram of an embodiment of the invention. The present invention aims to stabilize sub-output voltage of a power supply and reduce loss. The power supply receives power from a power source 10. The power goes through an initial rectification through a first time commutation unit 12, and is transformed by a voltage transformation unit 15 to be output to a second time commutation unit 16. The second time commutation unit 16 has at least one high voltage output end which is coupled in parallel with a DC/DC converter 17 to transform the voltage at the high voltage output end to become a sub-output. The DC/DC converter 17 has a low voltage output end to deliver sub-output power. The high voltage output end and the low voltage output end have respectively a voltage of a preset regular duty value. The invention provides a bias correction device 2 to bridge the high voltage output end and the low voltage output end (in this embodiment one end with 5V is defined as the high voltage output end and another end with 3.3V is defined as the low voltage output end). The bias correction device 2 sets an ideal voltage difference. By bridging the high voltage output end and the low voltage output end an actual voltage difference between the high voltage output end and the low voltage output end is obtained. In the event that the actual voltage difference is greater than the ideal voltage difference a conductive connection is established between the high voltage output end and the low voltage output end. Through the voltage of the high voltage output end the voltage at the low voltage output end is boosted. Therefore the actual voltage difference can be maintained at the ideal voltage difference. In the event that the voltage at the low voltage output end is lower than the preset regular duty value, the bias correction device 2 can compensate the voltage of the low voltage output end through a higher voltage of the high voltage output end. Thus output fluctuation of the low voltage output end can be prevented.

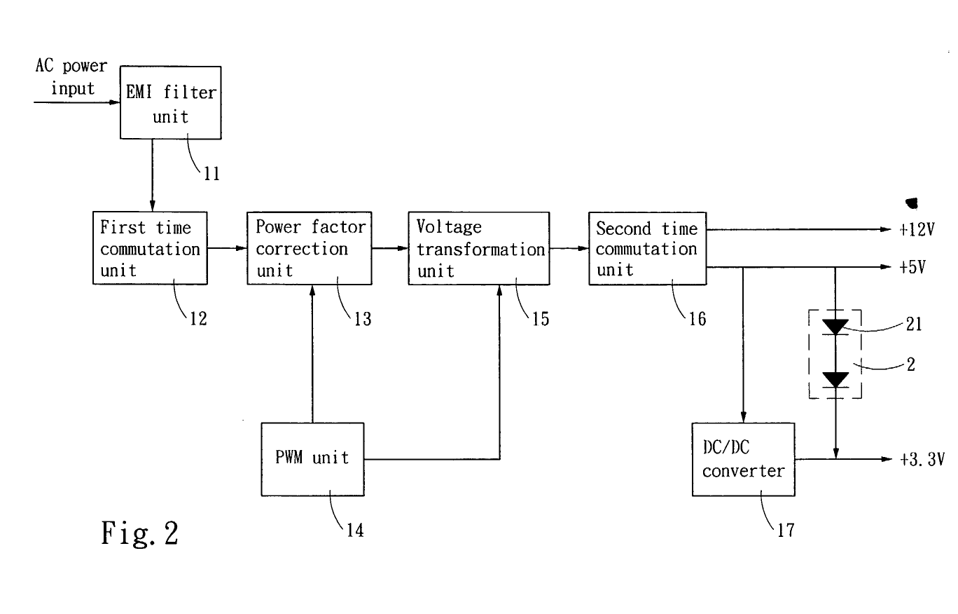

Refer to FIG. 2 for an embodiment of the invention. The power supply includes an EMI filter unit 11, the first time commutation unit 12, a power factor correction unit 13, a pulse width modulation (PWM) unit 14, the voltage transformation unit 15, the second time commutation unit 16 and the DC/DC converter 17. The bias correction device 2 bridges a high voltage output end which outputs 5V and a low voltage output end which outputs 3.3V. The bias correction unit 2 includes at least one one-way conductive element to allow current to flow only from the high voltage output end to the low voltage output end. Establishing of the conductive condition of the one-way conductive element is determined by the voltage difference of the two ends. The one-way conductive element has a threshold voltage value to establish the conductive condition thereof. The ideal voltage difference of the bias correction device 2 can be set by the one-way conductive element. The bias correction unit 2 can set the sum of the threshold voltage value of the one-way conductive element coupled in series to be the ideal voltage difference. The one-way conductive element may be a diode 21 as shown in FIG. 2, with the bias correction device 2 bridging the high voltage output end which outputs +5V and the low voltage output end which outputs +3.3V. To maintain output of the low voltage output end at 3.3V, the actual voltage difference between the high voltage output end and the low voltage output end must be 1.7V. Hence the bias correction device 2 may be formed by coupling in series two diodes 21 of a threshold voltage of 0.9V. The ideal voltage difference becomes 1.8V. When the power supply is in operation, if the output voltage at the low voltage output end does not reach 3.3V, the voltage difference with the high voltage output end is more than the ideal voltage difference 1.8V, then the bias correction device 2 consisting of the two diodes 21 becomes conductive. The high voltage output end compensates the lower output voltage of the low voltage output end. As a result the actual voltage difference is not greater than the ideal voltage difference, and the output voltage of the low voltage output end can be stabilized. The invention, in addition to stabilizing the voltage of the low voltage output end, also can substitute the resistor to serve as the virtual load. When the power supply is in operation, current flowing through the resistor that serves as the virtual load incurs continuous loss. By contrast, the invention employs one-way conductive element such as the diodes 21. When the output of the low voltage output end is in a normal condition, the bias correction device 2 is OFF, and no current passes through, thus no loss occurs. In the event that the output of the low voltage output end is too low, the bias correction device 2 is conductive, the loss generated is lower than that generated by the resistor. After compensation the output voltage at the low voltage output end rises, the bias correction device 2 is set OFF immediately. Hence the loss can be minimized.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A bias correction device used on a power supply which includes at least a power source and a voltage transformation unit, the voltage transformation unit having a high voltage output end coupling in parallel with a DC/DC converter extended to form a low voltage output end, wherein:
the bias correction device bridges the high voltage output end and the low voltage output end and is set with an ideal voltage difference, and forms a conductive condition between the high voltage output end and the low voltage output end when an actual voltage difference between the high voltage output end and the low voltage output end is obtained and greater than the ideal voltage difference, the voltage of the low voltage output end being raised by the voltage of the high voltage output end to maintain the actual voltage difference at the ideal voltage difference.

2. The bias correction device of claim 1, wherein the bias correction device includes at least one one-way conductive element which allows current to flow only from the high voltage output end to the low voltage output end, and becomes conductive when the actual voltage difference is greater than the ideal voltage difference.

3. The bias correction device of claim 2, wherein conductive of the one-way conductive element is determined by the voltage difference of two ends thereof, the one-way conductive element having a threshold voltage value to become conductive.

4. The bias correction device of claim 3, wherein the ideal voltage difference is the sum of the threshold voltage value of the one-way conductive element coupled in series.

5. The bias correction device of claim 4, wherein the one-way conductive element is a diode.
